(19) United States
(12) Patent Application Publication
(10) Pub. No.: US 2025/0375338 A1
(43) Pub. Date: Dec. 11, 2025

(54) FOOT STRETCHING STRAP

(71) Applicant: FIT GENO LLC, NEW YORK, NY (US)

(72) Inventor: CHUNMEI LIU, Panzhihua (CN)

(21) Appl. No.: 18/735,297

(22) Filed: Jun. 6, 2024

(51) Int. Cl. A63B 23/10; A63B 21/00; A63B 23/00

(52) U.S. Cl. CPC A61H 1/0266; A63B 2023/006

(57) ABSTRACT

A foot stretching strap includes a leg strap, a connection strap, a plantar support plate, and a foot strap. The leg strap is wrapped around a user's leg, secured by bonding, and connected to the plantar support plate by two connection straps having adjustable length. The foot strap is positioned on the user's foot and fixed in the plantar support plate by bonding. The leg strap and connection strap within this foot stretching strap offer adjustability to accommodate various leg types, ensuring adaptability and practicality, meeting the needs of different users. At the same time, the plantar support plate provided with a shaping plate and the foot strap can also improve a comfort during stretching.

### TECHNICAL FIELD

The present disclosure relates to the field of foot stretching technologies, and in particular, to a foot stretching strap.

### BACKGROUND

The foot stretching strap is a tool used to help the stretch plantar fascia and muscles. This type of device typically consists of a strap or strip, with one end fixed to the front of foot and the other end fixed to the heel. When using the foot stretching strap, people can stretch the plantar fascia and muscles by stretching the straps, thereby alleviating foot pain, improving foot flexibility, and preventing or treating some foot related problems.

This existing structure of the foot stretching strap is relatively simple, and does not provide adequate fixation for the user's leg or foot, nor does it accommodate different leg types. Therefore, an improvement is necessary. Hence, a foot stretching strap that address the issues raised in the background technology is required.

### SUMMARY

To address the aforementioned technical challenges, the present disclosure introduces a foot stretching strap, including a leg strap, a connection strap, a plantar support plate, and a foot strap; the leg strap is wrapped around a user's leg by binding, and the leg strap is connected to the foot strap by two connection straps having adjustable length; the foot strap is sleeved on the user's foot and secured within the plantar support plate by bonding; one end of the leg strap is provided with a head pull buckle, and the other end thereof is provided with a tail pull buckle; an inner side surface of the leg strap close to the head pull buckle is respectively provided with a first stickable surface and a second stickable surface.

In an embodiment of the present disclosure, an outer side surface of the leg strap located at one side of the tail pull buckle is provided with a third stickable surface and a fourth stickable surface.

In an embodiment of the present disclosure, the connection strap includes a strap body, an adjustable tension buckle, and an anti-release buckle, where the anti-release buckle is provided at an upper of the strap body; one end of the strap body is connected to the leg strap, and the other end thereof passes through the adjustable tension buckle and the anti-release buckle that are provided on the plantar support plate.

In an embodiment of the present disclosure, an inner side surface of the plantar support plate is a fifth stickable surface, which is bonded to the foot strap, and the plantar support plate is further provided with a shaping plate.

In an embodiment of the present disclosure, the shaping plate is an arc-shaped structure with an angle ranging from 15° to 90°.

In an embodiment of the present disclosure, an outer side surface of the foot strap is provided with a sixth two-stage stickable surface, and there is a seventh stickable surface in the sixth stickable surface; the seventh stickable surface is bonded and fixed to the fifth stickable surface.

In an embodiment of the present disclosure, a middle of the inner side surface of the foot strap is provided with a filling type buffer pad, and the filling type buffer pad has a thickness ranging from 1 mm to 50 mm; one end of the inner side surface of the foot strap is further provided with an eighth stickable surface, which is attached to the sixth stickable surface.

In an embodiment of the present disclosure, the sixth stickable surface of the foot strap is further attached to a movable strap, two ends of the movable strap are provided with a ninth stickable surface, the ninth stickable surface is bonded to the sixth stickable surface, and an inner side surface of the movable strap is provided with an anti-slip tape.

The technical benefits of the present disclosure:
the adjustability of the leg strap and connection strap accommodates various leg types, thereby enhancing practicality and meeting the needs of different users. Furthermore, the inclusion of the plantar support plate provided with a shaping plate and the foot strap enhances comfort during stretching.

### BRIEF DESCRIPTION OF DRAWINGS

FIG. 1 is a schematic structural diagram of a foot stretching strap provided in an embodiment of the present application.

FIG. 2 is a schematic structural diagram of the foot stretching strap provided in an embodiment of the present application.

FIG. 3 is a schematic structural diagram of an outer side surface of a foot strap in the foot stretching strap provided in an embodiment of the present application.

FIG. 4 is a schematic structural diagram of an inner side surface of the foot strap in the foot stretching strap provided in an embodiment of the present application.

FIG. 5 shows an effect of wearing the foot stretching strap provided in an embodiment of the present application.

Numeral reference: 1. leg strap; 2. connection strap; 3. plantar support plate; 4. foot strap; 11. head pull buckle; 12. tail pull buckle; 13. first stickable surface; 14. second stickable surface; 15. third stickable surface; 16. fourth stickable surface; 21. strap body; 22. adjustable tension buckle; 23. anti-release buckle; 31. shaping plate; 32. fifth stickable surface; 41. sixth two-stage stickable surface; 42. seventh stickable surface; 43. movable strap; 44. filling type buffer pad; 45. eighth stickable surface; 431. ninth stickable surface; 432. anti-slip tape.

### DESCRIPTION OF EMBODIMENTS

Below, a further detailed explanation of the present disclosure will be provided along with the accompanying drawings and specific embodiments. The embodiments of the present disclosure are served as examples for descriptive purposes, and are not exhaustive or limited to the disclosed form. Many modifications and changes are obvious to those skilled in the art. The selection and description of embodiments are aim to illustrate the principles and practical applications of the present disclosure, and to enable those skilled in the art to understand the present disclosure and design various embodiments with modifications suitable for specific purposes.

### Embodiment

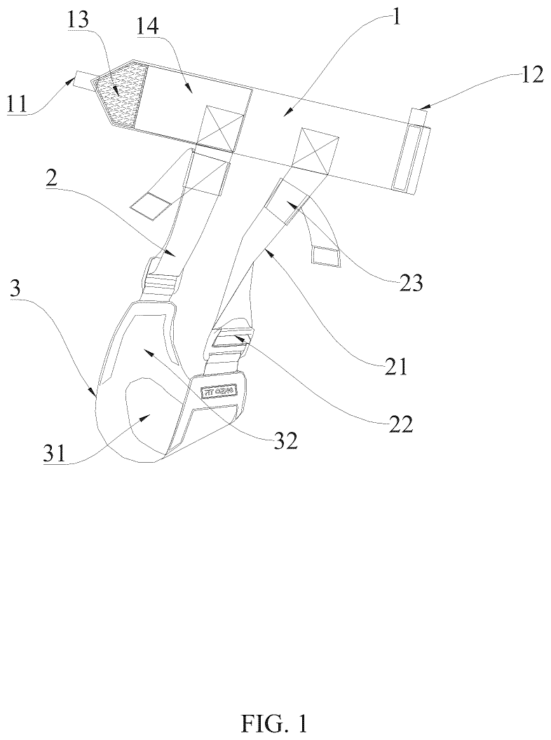

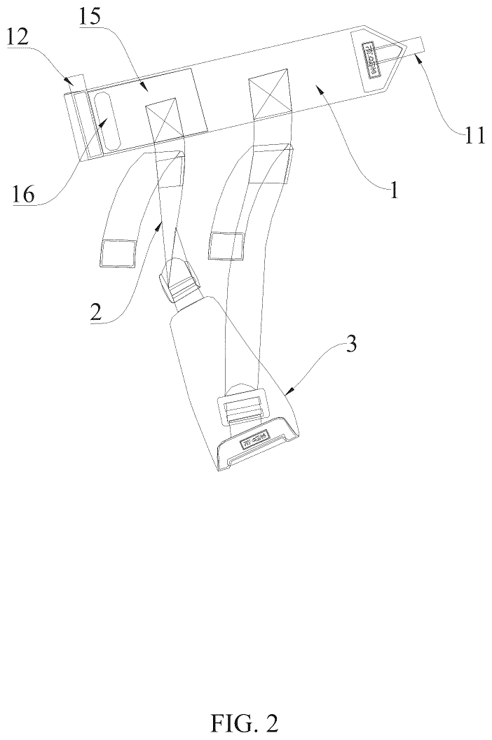

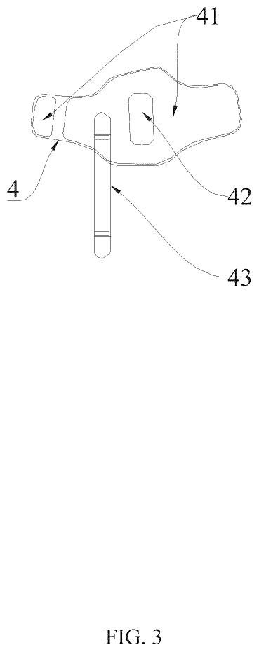

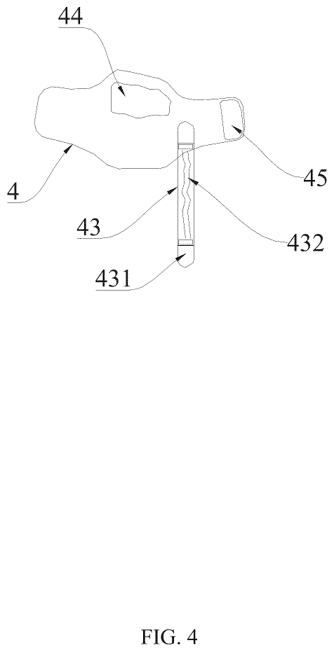

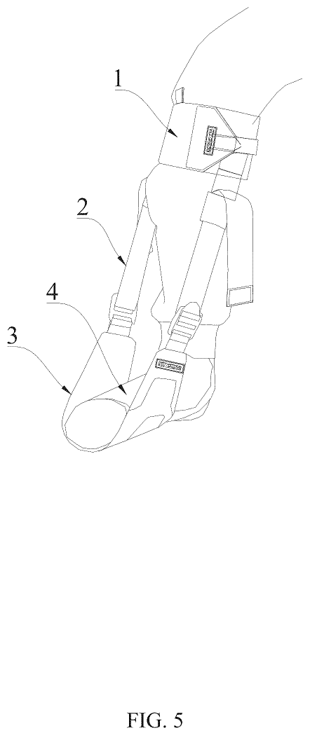

Please refer to FIGS. 1 to 5. In this embodiment, a foot stretching strap is introduced, which includes a leg strap 1, a connection strap 2, a plantar support plate 3, and a foot strap 4. A main body of the leg strap 1 is made of an elastic material, and the leg strap 1 is wrapped around a user's leg by bonding, the leg strap 1 is connected to the foot strap 4 by two connection straps 3 with adjustable length, the connection strap 2 can adjust length to adapt to users of different heights and body types. In addition, the foot strap 4 is sleeved on the user's foot and secured within the plantar support plate 3 by bonding, preventing foot sliding during applying a force.

In an implementation, one end of the leg strap 1 is provided with a head pull buckle 11, and the other end thereof is provided with a tail pull buckle 12. This design facilitates winding and binding of the leg strap 1, thereby improving the convenience of operation. In addition, an inner side surface of the leg strap 1 close to the head pull buckle 11 is respectively provided with a first stickable surface 13 and a second stickable surface 14.

Correspondingly, on one side of the tail pull buckle 12, there are a third stickable surface 15 and a fourth stickable surface 16 on an outer side surface of the leg strap 1. When wearing the leg strap 1, the first stickable surface 13 is wrapped around a rear of the leg and forward one circle to attach it to the third stickable surface 15. A position of the first stickable surface 13 on the third stickable surface 15 is adjusted to adapt to the changes in leg shape of different groups. When the leg strap 1 reaches a minimum range, the fourth stickable surface 16 is attached to the second stickable surface 14, thereby providing stable fixation and completing the wearing process.

The connection strap 2 includes a strap body 21, an adjustable tension buckle 22, and an anti-release buckle 23. The anti-release buckle 23 is provided at an upper of the strap body 21, one end of the strap body 21 is connected to the leg strap 1, the other end thereof passes through the adjustable tension buckle 22 and anti-release buckle 23 that are provided on the plantar support plate 3, and then the strap body 21 is tightened to achieve a length fixation of the strap body 21.

The structure described above is depicted in the attached drawings of the present application, and the connection strap 2 can be configured in various forms, such as using a buckle and a hook. The strap body 21 is provided with two sub buckles at two ends, allowing it to be secured by folding and tightening a woven strap, creating a two-stage structure for the connecting strap 2 as a whole.

An inner side surface of the plantar support plate 3 is a fifth stickable surface 32, which is bonded to the foot strap 4 for stabilization. Additionally, the plantar support plate 3 is further provided with a shaping plate 31, to provide optimal support for the user's foot. The shaping plate 31 is an arc-shaped structure with an angle ranging from 15° to 90°.

An outer side surface of the foot strap 4 is provided with a sixth two-stage stickable surface 41, and there is a seventh stickable surface 42 located in the sixth stickable surface 41. The seventh stickable surface 42 is bonded and fixed to the fifth stickable surface 32 to achieve a fixation of the foot strap 4.

A middle of the inner side surface of the foot strap 4 is provided with a filling type buffer pad 44, which has a thickness ranging from 1 mm to 50 mm. Additionally, one end of the inner side surface of the foot strap 4 is further provided with an eighth stickable surface 45, which is adhered to the sixth stickable surface 41. When wearing the foot strap 4, the forefoot of the foot is rest on the filling type buffer pad 44, and two ends of the foot strap 4 are interlocked, that is, the eighth stickable surface 45 is bonded and secured to the sixth stickable surface 41.

The sixth stickable surface 41 of the foot strap 4 is further attached with a movable strap 43. Two ends of the movable strap 43 are provided with a ninth stickable surface 431, the ninth stickable surface 431 is adhered to the sixth stickable surface 41. An inner side surface of the movable strap 43 is provided with an anti-slip tape 432. During usage, the movable strap 43 wraps around the heel of the foot and both ends are adhered on the sixth stickable surface 41.

It should be noted that the movable strap 43 can also be configured to be two stages, with two strip main bodies in a middle, connected by an adjustable buckle, and connected to the sixth stickable surface 41 at both ends or one end.

The leg strap 1 and connection strap 2 in the foot stretching strap of the present disclosure can be adjusted to adapt to different leg shapes, offering excellent adaptability and practicality, and meeting the diverse needs of users. Additionally, the plantar support plate 3 provided with a shaping plate 31 and the foot strap 4 also enhance the comfort during stretching exercises.

The described embodiments are only a part of the embodiments of the present in disclosure, not all of them. Based on the embodiments in the present disclosure, any other embodiments obtained by individuals skilled in this art and related fields without creative work fall within the protection scope of the present disclosure. Structures, devices, and operational methods specifically described and explained in the present disclosure, unless otherwise specified or limited, shall be implemented using conventional means within the relevant field.

What is claimed is:

1. A foot stretching strap, comprising a leg strap, a connection strap, a plantar support plate, and a foot strap; the leg strap is wrapped around a user's leg by bonding, and the leg strap is connected to the foot strap by two connection straps having adjustable length; the foot strap is sleeved on the user's foot and fixed in the plantar support plate by bonding;
one end of the leg strap is provided with a head pull buckle, and the other end thereof is provided with a tail pull buckle; an inner side surface of the leg strap close to the head pull buckle is respectively provided with a first stickable surface and a second stickable surface.

2. The foot stretching strap as claimed in claim 1, an outer side surface of the leg strap located at one side of the tail pull buckle is provided with a third stickable surface and a fourth stickable surface.

3. The foot stretching strap as claimed in claim 1, wherein the connection strap comprises a strap body, an adjustable tension buckle, and an anti-release buckle, wherein the anti-release buckle is provided at an upper of the strap body; one end of the strap body is connected to the leg strap, and the other end thereof passes through the adjustable tension buckle and the anti-release buckle that are provided on the plantar support plate.

4. The foot stretching strap as claimed in claim 3, wherein an inner side surface of the plantar support plate is a fifth stickable surface, which is bonded to the foot strap, and the plantar support plate is further provided with a shaping plate.

5. The foot stretching strap as claimed in claim 4, wherein the shaping plate is an arc-shaped structure with an angle ranging from 15° to 90°.

6. The foot stretching strap as claimed in claim 4, wherein an outer side surface of the foot strap is provided with a sixth two-stage stickable surface, and there is a seventh stickable surface in the sixth stickable surface; the seventh stickable surface is bonded and fixed to the fifth stickable surface.

7. The foot stretching strap as claimed in claim 6, wherein a middle of the inner side surface of the foot strap is provided with a filling type buffer pad, and the filling type buffer pad has a thickness of 1 mm to 50 mm; one end of the inner side surface of the foot strap is further provided with an eighth stickable surface, which is bonded to the sixth stickable surface.

8. The foot stretching strap as claimed in claim 7, wherein the sixth stickable surface of the foot strap is further affixed with a movable strap, two ends of the movable strap are provided with a ninth stickable surface, the ninth stickable surface is bonded to the sixth stickable surface, and an inner side surface of the movable strap is provided with an anti-slip tape.
